(19) United States
(12) Patent Application Publication
(10) Pub. No.: US 2016/0254655 A1
(43) Pub. Date: Sep. 1, 2016

(54) Straight-Through Power Lines

(71) Applicant: Michael Lewis Moravitz, Fairfax, VA (US)

(72) Inventor: Michael Lewis Moravitz, Fairfax, VA (US)

(21) Appl. No.: 14/999,153

(22) Filed: Apr. 4, 2016

(51) Int. Cl. H02G 7/00

(52) U.S. Cl. CPC H02G 7/00

(57) ABSTRACT

Send Electricity Over Power Lines without Capacitors to Reduce Resistance and power outages, and increase efficiency.

Power lines should be constructed with few or no capacitors.

Lightening striking capacitors cause power outages, and capacitors actually create resistance along the line that reduces efficiency. Channeling electricity through power stations and substations and then in homes, offices, and businesses—in which capacitors would be reduced or eliminated along the way—would be much more efficient, as well as reducing power outages from over-loaded circuits. My other patent application idea for air in vacuum tubes as a superconductor could also be used with this idea on power lines. Air, with particles reduced as much as possible, would conduct electricity better than any metals or other substances.

1) Builds on Patents for Power Lines; and

2) My current patent (submitted with this one) for Air in Vacuum Tubes as Superconductor.
